(19) United States
(12) Patent Application Publication
(10) Pub. No.: US 2026/0002572 A1
(43) Pub. Date: Jan. 1, 2026

(54) CYLINDRICAL VIBRATION ISOLATION DEVICE FOR VEHICLE AUXILIARY MACHINE

(71) Applicant: Sumitomo Riko Company Limited, Aichi (JP)

(72) Inventors: Takayoshi Yasuda, Aichi (JP); Mutsuki Nawaji, Aichi (JP)

(73) Assignee: Sumitomo Riko Company Limited, Aichi (JP)

(21) Appl. No.: 19/319,620

(22) Filed: Sep. 4, 2025

Related U.S. Application Data
(63) Continuation of application No. PCT/JP2024/004797, filed on Feb. 13, 2024.

(30) Foreign Application Priority Data
Jun. 12, 2023 (JP) 2023-096256

(51) Int. Cl. F16F 7/00

(52) U.S. Cl. CPC F16F 7/00; F16F 2224/025

(57) ABSTRACT

Provided is a cylindrical vibration isolation device for vehicle auxiliary machine having a novel structure, in which a main-body rubber elastic body having a low spring property suitable for a vehicle auxiliary machine can be employed. A cylindrical vibration isolation device 10 for vehicle auxiliary machine is provided with an inner shaft member 16 and an outer bracket 14 attached to one of a vehicle auxiliary machine 32 and a vehicle-body-side support member 34. A cylindrical part 44 externally fitted over the inner shaft member 16 is provided to the outer bracket 14. The inner shaft member 16 and the cylindrical part 44 are connected by a main-body rubber elastic body 20. The inner shaft member 16 is provided with a stopper protrusion 24 that protrudes to the outer peripheral side at a position protruding in an axial direction from the main-body rubber elastic body 20. The outer bracket 14 is provided with a first stopper part 46 having an axis-perpendicular contact surface 48 opposing the stopper protrusion 24 in an axis-perpendicular direction, and a second stopper part 50 having an axial-direction contact surface 52 opposing the stopper protrusion 24 in the axial direction, at positions protruding in the axial direction from the main-body rubber elastic body 20.

### CROSS-REFERENCE TO RELATED APPLICATION

The present application is a continuation of PCT/JP2024/004797, filed on Feb. 13, 2024, and is related to and claims priority from Japanese Patent Application No. 2023-096256 filed on Jun. 12, 2023. The entire contents of the aforementioned application are hereby incorporated by reference herein.

### TECHNICAL FIELD

The disclosure relates to a cylindrical vibration isolation device for vehicle auxiliary machine that supports a vehicle auxiliary machine such as electric compressor in a vibration isolation manner.

### BACKGROUND TECHNOLOGY

Conventionally, there is known a cylindrical vibration isolation device for vehicle auxiliary machine that supports a vehicle auxiliary machine such as electric compressor on a vehicle body in a vibration isolation manner. As shown, for example, by the main bush 130 in the specification of U.S. Pat. No. 11,078,985 (Patent Document 1), the cylindrical vibration isolation device for vehicle auxiliary machine has a structure in which an inner shaft member and an outer bracket having a cylindrical part are connected by a main-body rubber elastic body.

Meanwhile, a vehicle auxiliary machine such as electric compressor is relatively light, and because the input load to the vibration isolation device is small, a softer spring property is required for a cylindrical vibration isolation device for vehicle auxiliary machine compared to cylindrical vibration isolation devices used for engine mounts and suspension bushes.

However, when attempting to achieve a soft spring property by reducing the spring constant of the main-body rubber elastic body, there is a risk that the deformation amount of the main-body rubber elastic body may become large, or breakage of the main-body rubber elastic body may occur due to the large load during vehicle collision or aging deterioration of the main-body rubber elastic body. Furthermore, it was considered that large deformation or breakage of the main-body rubber elastic body may cause the vehicle auxiliary machine to collide with other members around or the ground, resulting in damage. In recent years, awareness of environmental issues has become notably prominent, and for example, if the electric compressor, which is a vehicle auxiliary machine, is damaged or if the piping of the electric compressor comes off, there is also concern about environmental burden resulting from refrigerant leakage.

The disclosure provides a cylindrical vibration isolation device for vehicle auxiliary machine with a novel structure that makes it possible to adopt a main-body rubber elastic body having a low spring property required for a vehicle auxiliary machine.

The following describes preferred aspects for understanding the disclosure, but each aspect below is described exemplarily and can be combined and used with each other as appropriate. What is more, multiple components described in each aspect can be recognized and adopted independently as much as possible, and can also be combined and used with any components described in other aspects as appropriate. Thus, in the disclosure, various other aspects can be realized without being limited to the aspects described below.

### SUMMARY

The first aspect is a cylindrical vibration isolation device for vehicle auxiliary machine that supports a vehicle auxiliary machine on a support member on a vehicle body side in a vibration isolation manner. The cylindrical vibration isolation device for vehicle auxiliary machine includes: an inner shaft member attached to one of the vehicle auxiliary machine and the support member; an outer bracket including a cylindrical part arranged at a distance on an outer peripheral side of the inner shaft member, and attached to the other of the vehicle auxiliary machine and the support member; and a main-body rubber elastic body connecting the inner shaft member and the cylindrical part of the outer bracket, in which the inner shaft member is provided with a stopper protrusion that protrudes toward the outer peripheral side at a position protruding in an axial direction from the main-body rubber elastic body, and the outer bracket is provided with a first stopper part having an axis-perpendicular contact surface opposing the stopper protrusion at a distance in an axis-perpendicular direction, and a second stopper part having an axial-direction contact surface opposing the stopper protrusion at a distance in the axial direction, at positions protruding in the axial direction from the main-body rubber elastic body.

A cylindrical vibration isolation device for vehicle auxiliary machine that supports a vehicle auxiliary machine lighter than a vehicle main machine in a vibration isolation manner requires a softer spring property (low spring property) compared to a cylindrical vibration isolation device for vehicle main machine. However, if the spring property against normal vibration input is set sufficiently low as required for a vehicle auxiliary machine, the relative displacement amount between the vehicle auxiliary machine and the support member on the vehicle body side may become excessively large at the time when a large load is input, causing problems such as contact between the vehicle auxiliary machine and other surrounding members or the ground. Therefore, in the cylindrical vibration isolation device for vehicle auxiliary machine structured according to this aspect, the relative displacement amount between the inner shaft member and the outer bracket is limited by the contact between the stopper protrusion of the inner shaft member and the first and second stopper parts of the outer bracket. This makes it possible to set the low spring property required for the cylindrical vibration isolation device for vehicle auxiliary machine while limiting the relative displacement amount between the vehicle auxiliary machine and the support member on the vehicle body side, thereby preventing contact between the vehicle auxiliary machine and other members or the ground.

Additionally, if the deformation amount of the main-body rubber elastic body at the time when a large load is input increases, breakage of the main-body rubber elastic body may occur. However, since the deformation amount of the main-body rubber elastic body is limited by the contact between the stopper protrusion and the first and second stopper parts, excessive deformation of the main-body rubber elastic body is avoided, thereby preventing breakage of the main-body rubber elastic body.

Even if the main-body rubber elastic body breaks, separation of the inner shaft member and the outer bracket is prevented by the contact between the stopper protrusion of the inner shaft member and the second stopper part of the outer bracket. Therefore, it is possible to prevent the vehicle auxiliary machine from separating and falling off from the vehicle body side, thereby preventing damage to the vehicle auxiliary machine resulting from hitting the ground. Moreover, since the relative displacement amount between the inner shaft member and the outer bracket in the axis-perpendicular direction is limited by the contact between the stopper protrusion and the first stopper part, the opposing state between the stopper protrusion and the second stopper part in the axial direction is less likely to be released, which stably prevents the vehicle auxiliary machine from falling off from the support member.

According to the second aspect, in the cylindrical vibration isolation device for vehicle auxiliary machine described in the first aspect, the stopper protrusion is a flange part that protrudes toward an outer periphery around an entire circumference of the inner shaft member, the outer bracket is provided with a cylindrical peripheral wall part that extends axially outward from the cylindrical part, and the first stopper part is configured by the cylindrical peripheral wall part, and the second stopper part is configured by an inner flange-shaped part that protrudes annularly toward an inner periphery from the cylindrical peripheral wall part.

According to the cylindrical vibration isolation device for vehicle auxiliary machine structured in accordance with this aspect, the relative displacement amount in the axial direction between the vehicle auxiliary machine and the support member is limited by the contact between the flange part that is continuous around the entire circumference and the inner flange-shaped part that is formed annularly, thereby securing a large contact area and achieving distribution of the stopper load. Additionally, the displacement amount in the prying direction in which the inner shaft member and the outer bracket relatively tilt is also limited by the contact between the flange part and the inner flange-shaped part.

Additionally, since the relative displacement amount in the axis-perpendicular direction between the vehicle auxiliary machine and the support member is limited by the contact between the flange part and the cylindrical peripheral wall part, the relative displacement amount between the inner shaft member and the outer bracket can be limited in all axis-perpendicular directions.

According to the third aspect, the cylindrical vibration isolation device for vehicle auxiliary machine described in the first or second aspect further includes a stopper rubber provided between the stopper protrusion and the outer bracket, in which the stopper rubber includes an axis-perpendicular buffer rubber arranged between opposing surfaces of the stopper protrusion and the first stopper part, and an axial-direction buffer rubber arranged between opposing surfaces of the stopper protrusion and the second stopper part.

According to the cylindrical vibration isolation device for vehicle auxiliary machine structured in accordance with this aspect, as the stopper rubber disposed between the stopper protrusion and the outer bracket includes the axis-perpendicular buffer rubber and the axial-direction buffer rubber, when the stopper protrusion comes into contact with the first stopper part and when the stopper protrusion comes into contact with the second stopper part, impact noise and shock are reduced by the buffering property of the stopper rubber.

According to the fourth aspect, in the cylindrical vibration isolation device for vehicle auxiliary machine described in the third aspect, the stopper rubber is integrally formed with the main-body rubber elastic body and is fixed to the stopper protrusion of the inner shaft member.

According to the cylindrical vibration isolation device for vehicle auxiliary machine structured in accordance with this aspect, since the stopper rubber including the axis-perpendicular buffer rubber and the axial-direction buffer rubber is integrally formed with the main-body rubber elastic body and is fixed to the stopper protrusion, the process of forming the stopper rubber separately from the main-body rubber elastic body becomes unnecessary, which can make the manufacturing easy and also reduce the number of parts.

According to the fifth aspect, in the cylindrical vibration isolation device for vehicle auxiliary machine described in any one of the first to fourth aspects, the vehicle auxiliary machine is an electric compressor.

According to the cylindrical vibration isolation device for vehicle auxiliary machine structured in accordance with this aspect, even if the vehicle auxiliary machine is an electric compressor that generates vibration during operation, the vehicle auxiliary machine is supported on the support member on the vehicle body side in a vibration isolation manner, so vibration transmission to the support member side is suppressed.

In addition, since the electric compressor is significantly lighter than a vehicle main machine such as engine, a softer spring property is required for the main-body rubber elastic body. If the spring constant of the main-body rubber elastic body is set smaller, the deformation amount of the main-body rubber elastic body increases at the time when a large load is input, and breakage also becomes more likely to occur. However, since the relative displacement amount between the inner shaft member and the outer bracket is respectively limited in the axis-perpendicular direction and the axial direction, excessive deformation of the main-body rubber elastic body is avoided, and interference with other members due to displacement of the electric compressor or contact with the ground due to falling off is prevented.

Further, for example, if the electric compressor is damaged by contact with other members or the ground, or if the piping of the electric compressor comes off, refrigerant that adversely affects the environment may leak from the electric compressor. Therefore, by preventing the electric compressor from coming into contact with other members or the ground with the stopper mechanism in which the stopper protrusion of the inner shaft member contacts the first and second stopper parts of the outer bracket, leakage of refrigerant due to damage to the electric compressor can be prevented to prevent environmental pollution, etc.

According the sixth aspect, the cylindrical vibration isolation device for vehicle auxiliary machine described in any one of the first to fifth aspects further includes an outer cylindrical member that is arranged at a distance on the outer peripheral side of the inner shaft member and is fixed to the main-body rubber elastic body, in which the outer cylindrical member is press-fit fixed to the cylindrical part of the outer bracket.

According to the cylindrical vibration isolation device for vehicle auxiliary machine structured in accordance with this aspect, since the outer cylindrical member, which is a separate member from the outer bracket attached to the vehicle auxiliary machine or the support member on the vehicle body side, is fixed to the main-body rubber elastic body, there is no need to provide an attachment structure to the support member on the vehicle body side for the outer cylindrical member fixed to the main-body rubber elastic body. Therefore, the vulcanized molded product of the main-body rubber elastic body before mounting the outer bracket can be made smaller, and production efficiency can be improved.

According to the seventh aspect, in the cylindrical vibration isolation device for vehicle auxiliary machine described in any one of the first to sixth aspects, the inner shaft member has a central axis that extends in a vehicle up-down direction, the vehicle auxiliary machine is attached to a lower side of the inner shaft member, and the outer bracket is attached to the support member above the vehicle auxiliary machine.

According to the cylindrical vibration isolation device for vehicle auxiliary machine structured in accordance with this aspect, since the vehicle auxiliary machine is supported in a suspended state, at the time of breakage of the main-body rubber elastic body, the vehicle auxiliary machine undergoes relative displacement downward relative to the vehicle body due to gravity, but the contact between the stopper protrusion and the second stopper part can prevent the vehicle auxiliary machine from separating and falling off from the vehicle body side.

According to the eighth aspect, in the cylindrical vibration isolation device for vehicle auxiliary machine described in any one of the first to seventh aspects, the stopper protrusion is integrally formed with the inner shaft member.

According to the cylindrical vibration isolation device for vehicle auxiliary machine structured in accordance with this aspect, the number of parts can be reduced compared to a case where the stopper protrusion is made as a separate component from the inner shaft member.

According to the disclosure, in the cylindrical vibration isolation device for vehicle auxiliary machine, it is possible to adopt a main-body rubber elastic body having a low spring property required for a vehicle auxiliary machine.

### BRIEF DESCRIPTION OF THE DRAWINGS

FIG. 1 is a vertical cross-sectional view showing a vibration isolation mount as the first embodiment of the disclosure in a vehicle mounted state, and is a view corresponding to the cross-section I-I of FIG. 4.

FIG. 2 is a vertical cross-sectional view of a mount main body constituting the vibration isolation mount shown in FIG. 1.

FIG. 3 is a perspective view of the vehicle mounted state of the vibration isolation mount shown in FIG. 1.

FIG. 4 is a front view of the vehicle mounted state of the vibration isolation mount shown in FIG. 3.

FIG. 5 is a plan view of the vehicle mounted state of the vibration isolation mount shown in FIG. 3.

FIG. 6 is a right side view of the vehicle mounted state of the vibration isolation mount shown in FIG. 3.

FIG. 7 is a vertical cross-sectional view of the vehicle mounted state of the vibration isolation mount shown in FIG. 1, and is a view showing a state where the electric compressor is displaced downward.

FIG. 8 is a vertical cross-sectional view of the vehicle mounted state of the vibration isolation mount shown in FIG. 1, and is a view showing a state where the electric compressor is displaced upward.

### DESCRIPTION OF THE EMBODIMENTS

The following describes embodiments of the disclosure with reference to the figures.

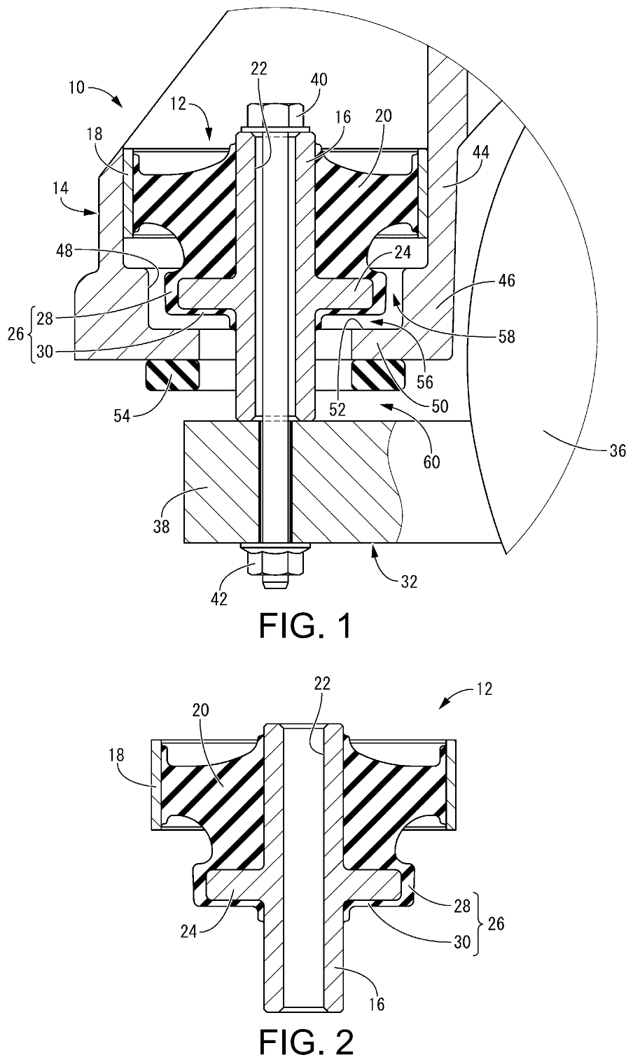

FIG. 1 shows a vibration isolation mount 10 for electric compressor as the first embodiment of the cylindrical vibration isolation device for vehicle auxiliary machine according to the disclosure. The vibration isolation mount 10 has a structure in which an outer bracket 14 is mounted to a mount main body 12. In the following description, in principle, the up-down direction refers to the vertical up-down direction, which is the mount central axis direction, that is, the up-down direction in FIG. 1.

The mount main body 12, as also shown in FIG. 2, has a structure in which an inner shaft member 16 is inserted into an outer cylindrical member 18, and the space between the inner shaft member 16 and the outer cylindrical member 18 in the radial direction is elastically connected by a cylindrical main-body rubber elastic body 20.

The inner shaft member 16 is a small-diameter cylindrical member made of metal or fiber reinforced synthetic resin, and extends linearly in the up-down direction. The inner hole of the inner shaft member 16 is a bolt hole 22 with a circular cross-section that penetrates in the axial direction.

In the intermediate portion of the inner shaft member 16 in the axial direction, a stopper protrusion 24 is formed to protrude to the outer periphery in the axis-perpendicular direction. The stopper protrusion 24 is formed into a ring plate-shaped flange part, and is provided continuously around the entire circumference with an approximately constant cross-sectional shape. The stopper protrusion 24 is provided below the center of the inner shaft member 16 in the axial direction. In this embodiment, the stopper protrusion 24 is integrally formed with the inner shaft member 16, but for example, a ring plate-shaped stopper protrusion may be made as a separate component from the inner shaft member, and the stopper protrusion may be provided to be externally fitted to the outer peripheral surface of the inner shaft member.

The outer cylindrical member 18 is made of metal or fiber reinforced synthetic resin, and has a thin-walled large-diameter approximately cylindrical shape compared to the inner shaft member 16. In this embodiment, the outer cylindrical member 18 extends straight with approximately constant inner and outer diameters in the axial direction. The length dimension of the outer cylindrical member 18 in the axial direction is made smaller than the length dimension of the inner shaft member 16 in the axial direction, preferably half or less, and more preferably ⅓ or less of the inner shaft member 16.

The inner shaft member 16 is inserted through to the inner peripheral side of the outer cylindrical member 18. The inner shaft member 16 has the upper and lower end portions protruding outward vertically beyond the outer cylindrical member 18, and is arranged to protrude more greatly downward than upward with respect to the outer cylindrical member 18. The stopper protrusion 24 of the inner shaft member 16 is positioned at a distance below the outer cylindrical member 18.

Then, the inner shaft member 16 and the outer cylindrical member 18, which are arranged in the inner-outer inserted state as described above, are connected to each other by the main-body rubber elastic body 20. The main-body rubber elastic body 20 is formed into an upside-down truncated cone shape that becomes smaller in diameter downward as a whole, and the inner peripheral end portion is adhered to the inner shaft member 16 by vulcanization and the outer peripheral end portion is adhered to the outer cylindrical member 18 by vulcanization.

The stopper protrusion 24 of the inner shaft member 16 is provided at a position protruding downward beyond the main-body rubber elastic body 20, and the lower end portion of the main-body rubber elastic body 20 is fixed to the upper surface of the stopper protrusion 24. Additionally, the stopper protrusion 24 is covered by a first stopper rubber 26 serving as a stopper rubber. The first stopper rubber 26 includes an axis-perpendicular buffer rubber 28 covering the outer peripheral surface of the stopper protrusion 24, which is the opposing surface to the axis-perpendicular contact surface 48 to be described later, and an axial-direction buffer rubber 30 covering the lower surface of the stopper protrusion 24, which is the opposing surface to the axial-direction contact surface 52 to be described later. In this embodiment, the first stopper rubber 26 is integrally formed with the main-body rubber elastic body 20, and is adhered to the inner shaft member 16 by vulcanization together with the main-body rubber elastic body 20. In this embodiment, the axis-perpendicular buffer rubber 28 is made thicker than the axial-direction buffer rubber 30. It should be noted that the first stopper rubber 26 is integrally continuous with the main-body rubber elastic body 20 at the upper end portion of the axis-perpendicular buffer rubber 28. Also, the first stopper rubber 26 protrudes slightly downward from the inner peripheral end portion of the axial-direction buffer rubber 30 and is fixed to the outer peripheral surface of the inner shaft member 16 below the stopper protrusion 24.

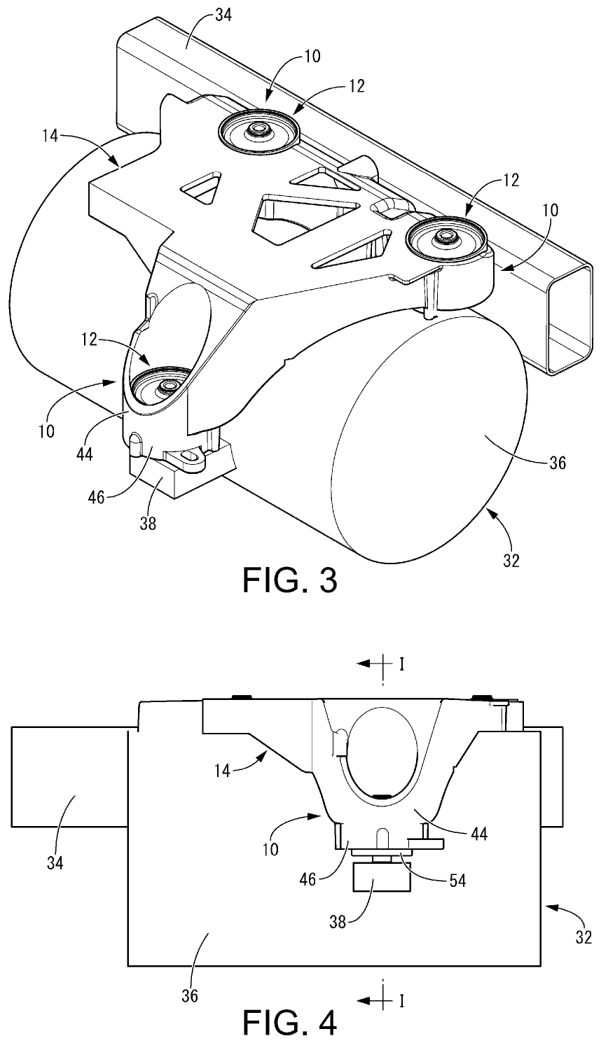

The mount main body 12 having such a structure is interposed between an electric compressor 32 as a vehicle auxiliary machine and an outer bracket 14 fixed to a support member 34 on the vehicle body side, as shown in FIG. 1. That is, the mount main body 12 is mounted to the vehicle by attaching the inner shaft member 16 to the electric compressor 32 and attaching the outer cylindrical member 18 to the outer bracket 14 fixed to the support member 34. Then, in the vehicle mounted state of the mount main body 12, the electric compressor 32 is connected to the support member 34 on the vehicle body side in a vibration isolation manner via the vibration isolation mount 10, as shown in FIG. 3 to FIG. 6.

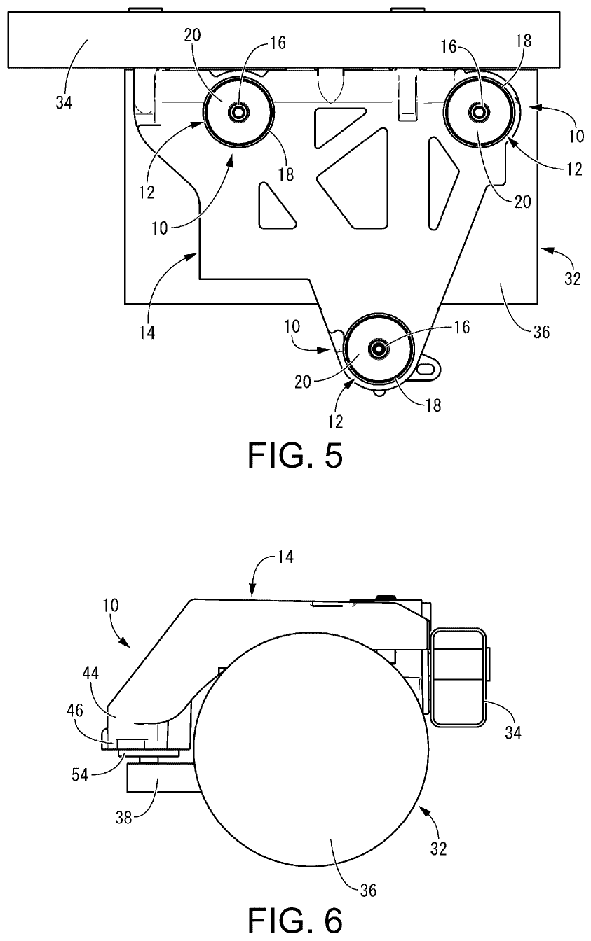

In this embodiment, as shown in FIG. 3 and FIG. 5, the electric compressor 32 is connected to the support member 34 on the vehicle body side in a vibration isolation manner by three mount main bodies 12, but the following will only describe the vehicle mounted state of one mount main body 12, and the descriptions for the other two will be omitted as they are similar. It should be noted that in this embodiment, the three mount main bodies 12 are attached to one outer bracket 14, but since each vibration isolation mount 10 is configured by the combination of each mount main body 12 and the outer bracket 14, as shown in FIG. 5, the electric compressor 32 is supported by three vibration isolation mounts 10 in a vibration isolation manner.

The inner shaft member 16, as shown in FIG. 1, has the lower end surface overlapped with the upper surface of a fastening part 38 that protrudes from a housing 36 of the electric compressor 32, and is bolt-fixed to the electric compressor 32 by a bolt 40 inserted through the bolt hole 22 of the inner shaft member 16 and the bolt hole 22 penetrating vertically through the fastening part 38. In FIG. 5, the inner shaft member 16 and the fastening part 38 of the electric compressor 32 are fastened by a nut 42 screwed onto the bolt 40, but for example, the bolt 40 may be screwed into a threaded hole formed in the fastening part 38. It should be noted that the housing 36 of the electric compressor 32 is formed into a hollow columnar shape, and a compressor body (not shown) is accommodated inside.

The outer cylindrical member 18 is press-fit fixed to a cylindrical part 44 provided on the outer bracket 14. In this embodiment, the outer cylindrical member 18 that is adhered to the main-body rubber elastic body 20 by vulcanization and the outer bracket 14 fixed to the support member 34 on the vehicle body side are made as separate components, and by press-fit fixing the outer cylindrical member 18 to the outer bracket 14, the cylindrical part 44 of the outer bracket 14 is arranged at a distance on the outer peripheral side of the inner shaft member 16, and the inner shaft member 16 and the cylindrical part 44 of the outer bracket 14 are connected to each other by the main-body rubber elastic body 20. With this structure where the outer cylindrical member 18 and the outer bracket 14 are separate components, the size of the mount main body 12, which is an integrally vulcanized molded product of the main-body rubber elastic body 20, can be reduced. It should be noted that the vibration isolation mount 10 of this embodiment has a structure in which the outer bracket 14 is mounted to the mount main body 12.

In addition, the outer bracket 14 is provided with a cylindrical peripheral wall part 46 with a cylindrical shape that protrudes downward from the cylindrical part 44, and the cylindrical peripheral wall part 46 extends downward beyond the stopper protrusion 24 of the inner shaft member 16. The cylindrical peripheral wall part 46, serving as a first stopper part, surrounds the outer periphery of the stopper protrusion 24, and the inner peripheral surface opposing the outer peripheral surface of the stopper protrusion 24 in the radial direction is used as the axis-perpendicular contact surface 48.

At the lower end portion of the cylindrical peripheral wall part 46, an inner flange-shaped part 50 serving as a second stopper part is provided, which protrudes annularly toward the inner periphery around the entire circumference. The inner flange-shaped part 50 is positioned below the stopper protrusion 24 of the inner shaft member 16, with the inner peripheral end portion opposing the stopper protrusion 24 in the up-down direction, while being spaced apart on the outer peripheral side from the portion of the inner shaft member 16 below the stopper protrusion 24. In the vibration isolation mount 10, the axial-direction buffer rubber 30 covering the lower surface of the stopper protrusion 24 of the inner shaft member 16 opposes the inner flange-shaped part 50 of the outer bracket 14, and is spaced apart upward by a predetermined stopper clearance. Additionally, the axis-perpendicular buffer rubber 28 covering the outer peripheral surface of the stopper protrusion 24 opposes the inner peripheral surface of the cylindrical peripheral wall part 46, and is spaced apart toward the inner periphery by a predetermined stopper clearance. The upper surface of the inner flange-shaped part 50, which opposes the lower surface of the stopper protrusion 24 in the up-down direction, is used as the axial-direction contact surface 52.

A second stopper rubber 54 is fixed to the lower surface of the inner flange-shaped part 50. The second stopper rubber 54 is formed into a ring shape and is overlapped on the lower surface of the inner peripheral end portion of the inner flange-shaped part 50. Then, in the vehicle mounted state of the vibration isolation mount 10, the lower surface of the second stopper rubber 54 opposes the fastening part 38 of the electric compressor 32, and is spaced apart upward by a predetermined stopper clearance.

The mount main body 12 is attached to the vehicle with the central axis of the inner shaft member 16 extending in the vehicle up-down direction, and the electric compressor 32 is attached to the lower side of the inner shaft member 16 and the outer bracket 14 is attached to the support member 34 above the electric compressor 32. Therefore, the electric compressor 32 is supported with vibration isolation to the support member 34 on the vehicle body side in a suspended state through the vibration isolation mount 10.

In such a vehicle mounted state of the vibration isolation mount 10, when vibration caused by the operation of the electric compressor 32 is input between the inner shaft member 16 and the outer cylindrical member 18, the intended vibration isolation effect is exhibited through the vibration isolation action and vibration damping action during elastic deformation of the main-body rubber elastic body 20. It should be noted that, at the time of normal vibration input as shown in FIG. 6, the first stopper rubber 26 covering the stopper protrusion 24 is maintained in a state spaced apart from the cylindrical peripheral wall part 46 and the inner flange-shaped part 50 of the outer bracket 14. In addition, at the time of normal vibration input, the fastening part 38 of the electric compressor 32 is maintained in a state spaced apart downward from the second stopper rubber 54 covering the lower surface of the inner flange-shaped part 50 of the outer bracket 14.

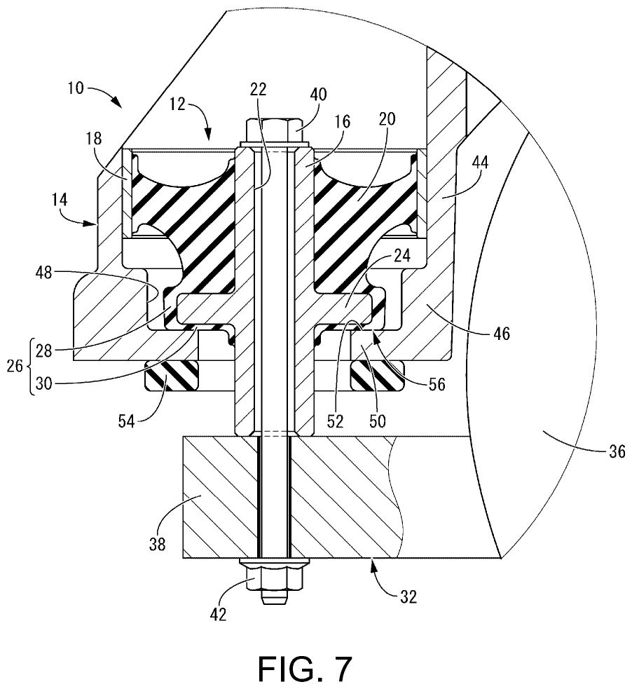

As shown in FIG. 7, in a case where the electric compressor 32 is greatly displaced downward relative to the support member 34 on the vehicle body side, the stopper protrusion 24 of the inner shaft member 16 fixed to the electric compressor 32 comes into contact with the axial-direction contact surface 52 of the inner flange-shaped part 50 of the outer bracket 14 in the up-down direction through the axial-direction buffer rubber 30 of the first stopper rubber 26. This constitutes a first stopper mechanism 56 that limits the relative displacement amount of the inner shaft member 16 downward relative to the outer cylindrical member 18, thereby limiting the downward displacement of the electric compressor 32 relative to the support member 34. Therefore, the electric compressor 32 is prevented from hitting the ground or other surrounding members, which can prevent damage to the electric compressor 32 or other members.

FIG. 7 shows an example in which the first stopper mechanism 56 is configured in a state where the inner shaft member 16 and the outer cylindrical member 18 are connected by the main-body rubber elastic body 20. However, for example, even in a case where the main-body rubber elastic body 20 is broken by a large impact load, and the inner shaft member 16 and the outer cylindrical member 18 are released from the connection provided by the main-body rubber elastic body 20, the first stopper mechanism 56 is configured as the electric compressor 32 falls downward. Therefore, even at the time of breakage of the main-body rubber elastic body 20, the first stopper mechanism 56 prevents the electric compressor 32 from falling off downward.

Additionally, in a case where the electric compressor 32 is relatively displaced greatly in the radial direction relative to the support member 34 on the vehicle body side, the stopper protrusion 24 of the inner shaft member 16 and the axis-perpendicular contact surface 48 of the cylindrical peripheral wall part 46 of the outer bracket 14 come into contact with each other in the radial direction through the axis-perpendicular buffer rubber 28. This constitutes a second stopper mechanism 58 that limits the relative displacement amount in the radial direction between the inner shaft member 16 and the outer cylindrical member 18, thereby limiting the displacement of the electric compressor 32 in the radial direction relative to the support member 34. Therefore, the electric compressor 32 is prevented from hitting the outer bracket 14 or other surrounding members, which can prevent damage to the electric compressor 32, the outer bracket 14, and other surrounding members. In this embodiment, since the stopper protrusion 24 and the cylindrical peripheral wall part 46 are provided continuously around the entire circumference, the second stopper mechanism 58 is configured in all radial directions.

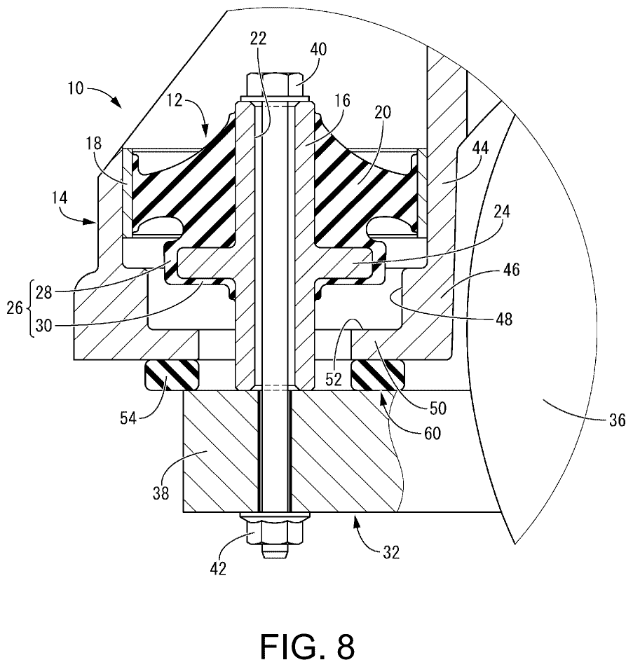

Further, as shown in FIG. 8, in a case where the electric compressor 32 is greatly displaced upward relative to the support member 34 on the vehicle body side, the fastening part 38 of the electric compressor 32 comes into contact with the inner flange-shaped part 50 of the outer bracket 14 in the up-down direction through the second stopper rubber 54. This constitutes a third stopper mechanism 60 that limits the relative displacement amount of the inner shaft member 16 upward relative to the outer cylindrical member 18, thereby limiting the upward displacement of the electric compressor 32 relative to the support member 34. Therefore, the electric compressor 32 is prevented from hitting the outer bracket 14, which can prevent damage to the electric compressor 32 and the outer bracket 14.

It should be noted that both the second stopper mechanism 58 and the third stopper mechanism 60, similar to the first stopper mechanism 56, limit the relative displacement amount between the inner shaft member 16 and the outer cylindrical member 18 even at the time of breakage of the main-body rubber elastic body 20.

As described above, with the vibration isolation mount 10 according to this embodiment, the relative displacement amount of the electric compressor 32 relative to the vehicle body (support member 34) at the time when a large load is input is limited, which can prevent damage to the electric compressor 32 caused by, for example, hitting other members or the ground. In particular, since refrigerant flows inside the electric compressor 32 used in vehicle air conditioners or the like, if the electric compressor 32 is damaged by hitting other members or the ground, there is a risk that the refrigerant leaking out may contaminate the surrounding environment. By adopting the vibration isolation mount 10 of this embodiment, damage to the electric compressor 32 is prevented, which can prevent environmental pollution due to refrigerant leakage.

Since the electric compressor 32, which is a vehicle auxiliary machine, is significantly lighter than a vehicle main machine (such as engine), the main-body rubber elastic body 20 requires a softer spring property than the main-body rubber elastic body of a cylindrical vibration isolation device for vehicle main machine such as an engine mount. However, if the spring constant of the main-body rubber elastic body 20 is set smaller, the deformation amount of the main-body rubber elastic body 20 increases at the time when a large load is input, or breakage becomes more likely to occur. Therefore, by providing the vibration isolation mount 10 with the first to third stopper mechanisms 56, 58, and 60 to respectively limit the relative displacement amount between the inner shaft member 16 and the outer bracket 14 in the axial direction and the axis-perpendicular direction, excessive deformation of the main-body rubber elastic body 20 and damage resulting from the deformation are avoided, thereby preventing the electric compressor 32 from hitting other members or the ground.

In this embodiment, the vibration isolation mount 10 is attached to the vehicle with the central axis of the inner shaft member 16 extending in the vehicle up-down direction, and the electric compressor 32 is attached to the lower side of the inner shaft member 16 while the outer bracket 14 is attached to the support member 34 above the electric compressor 32. In such a structure where the electric compressor 32 is supported in a suspended state by the vibration isolation mount 10, for example, at the time of breakage of the main-body rubber elastic body 20, the inner shaft member 16 relatively displaces downward in the axial direction relative to the outer bracket 14 due to gravity, but in such a case, the first stopper mechanism 56 prevents the electric compressor 32 from falling off.

In the vibration isolation mount 10, the stopper protrusion 24 constituting the first stopper mechanism 56 and the second stopper mechanism 58 is formed as a flange part provided continuously around the entire circumference. This makes it possible to secure a large contact area between the stopper protrusion 24 and the inner flange-shaped part 50 in the first stopper mechanism 56, and achieves reduction of impact sound through distribution of the stopper load and improvement of durability of the axial-direction buffer rubber 30. Additionally, since the second stopper mechanism 58 can be configured around the entire circumference, it is possible to limit the relative displacement amount between the inner shaft member 16 and the outer cylindrical member 18 against input in any radial direction, and there is no need to position the circumferential orientation when mounting the mount main body 12 to the vehicle, which simplifies the mounting work to the vehicle. Even in a case where the inner shaft member 16 and the outer cylindrical member 18 relatively displace in a prying direction, the relative displacement amount can be limited by the contact between the stopper protrusion 24 and the inner flange-shaped part 50.

Since both the first stopper mechanism 56 and the second stopper mechanism 58 have the first stopper rubber 26 interposed between the contact surfaces of the stopper protrusion 24 and the outer bracket 14, impact sound and shock that occur during contact between the stopper protrusion 24 and the outer bracket 14 are reduced. In this embodiment, the first stopper rubber 26 is integrally formed with the main-body rubber elastic body 20, which reduces the number of parts. Additionally, since the third stopper mechanism 60 has the second stopper rubber 54 interposed between the contact surfaces of the fastening part 38 of the electric compressor 32 and the outer bracket 14, impact sound and shock that occur during contact between the fastening part 38 and the outer bracket 14 are reduced.

While the embodiments of the disclosure have been described in detail above, the disclosure is not limited to the specific description. For example, the stopper protrusion, the first stopper part, and the second stopper part may be in any form that exhibits the function of limiting the deformation amount of the main-body rubber elastic body through contact in the axial direction or the axis-perpendicular direction, and are not necessarily provided continuously around the entire circumference, but may be provided partially in the circumferential direction. In a case where the stopper protrusion is provided partially in the circumferential direction, it is desirable that the stopper protrusion protrudes on both sides of at least one radial direction so that the stopper mechanism in the axis-perpendicular direction (the second stopper mechanism 58) is configured on both sides of at least one radial direction.

Additionally, the specific shape and size of the stopper protrusion 24 are not limited, but considering the influence on the vibration isolation property provided by the main-body rubber elastic body 20, it is desirable that the tip diameter of the stopper protrusion 24 is smaller than the outer diameter dimension of the main-body rubber elastic body 20. Furthermore, considering the support form and structure of the electric compressor (vehicle auxiliary machine) 32, it is also possible to configure the third stopper mechanism 60 using the stopper protrusion 24. Specifically, for example, a radially inward convex part that protrudes toward the inner peripheral side may be formed at the axial-direction end portion of the outer cylindrical member 18, and the third stopper mechanism may be configured to limit the axial-direction deformation amount of the main-body rubber elastic body 20 and prevent the inner shaft member 16 from being pulled out in the axial direction relative to the outer cylindrical member 18 at the time of breakage of the main-body rubber elastic body 20, through the contact action of the stopper protrusion 24 with such a radially inward convex part.

The above embodiment shows an example in which the main-body rubber elastic body 20 is fixed to the outer cylindrical member 18, and the outer cylindrical member 18 is press-fit fixed to the outer bracket 14 so that the inner shaft member 16 and the outer bracket 14 are elastically connected by the main-body rubber elastic body 20. However, for example, the main-body rubber elastic body 20 may be directly fixed to the inner peripheral surface of the cylindrical part 44 of the outer bracket 14.

In a case where multiple mount main bodies are attached to the outer bracket 14 as in the above embodiment, it is sufficient that at least one mount main body constitutes the cylindrical vibration isolation device according to the disclosure, and it is not necessary that all the mount main bodies constitute the cylindrical vibration isolation device according to the disclosure. It should be noted that one mount main body may be attached to one outer bracket.

The third stopper mechanism 60 illustrated in the above embodiment is not essential in the cylindrical vibration isolation device according to the disclosure, as can be understood from the fact that the third stopper mechanism 60 includes the electric compressor 32 as a component element, and can also be omitted. Further, a stopper mechanism that limits the upward displacement amount of the inner shaft member 16 relative to the outer bracket 14, which corresponds to the third stopper mechanism 60, may be provided in the cylindrical vibration isolation device.

In the above embodiment, the first stopper rubber 26 is fixed to the surface of the stopper protrusion 24, but the stopper rubber may be disposed between the opposing surfaces of the stopper protrusion 24 and the outer bracket 14. For example, the stopper rubber may be provided without being fixed to both the stopper protrusion 24 and the outer bracket 14, or may be fixed to the outer bracket 14 side. Specifically, for example, the stopper rubber may be fixed to the inner peripheral surface (axis-perpendicular contact surface 48) of the cylindrical peripheral wall part 46 and the upper surface (axial-direction contact surface 52) of the inner flange-shaped part 50 of the outer bracket 14. In this case, the stopper rubber is formed separately from the main-body rubber elastic body 20, and can also be integrally formed with the second stopper rubber 54 fixed to the lower surface of the inner flange-shaped part 50.

The vehicle auxiliary machine is not limited to the electric compressor 32 as exemplified. However, it is desirable that the vehicle auxiliary machine is lighter than a vehicle main machine (such as internal combustion engine) which serves as the driving power of the vehicle.

1. A cylindrical vibration isolation device for vehicle auxiliary machine, supporting a vehicle auxiliary machine on a support member on a vehicle body side in a vibration isolation manner, the cylindrical vibration isolation device for vehicle auxiliary machine comprising:
an inner shaft member attached to one of the vehicle auxiliary machine and the support member;
an outer bracket comprising a cylindrical part arranged at a distance on an outer peripheral side of the inner shaft member, and attached to the other of the vehicle auxiliary machine and the support member; and
a main-body rubber elastic body connecting the inner shaft member and the cylindrical part of the outer bracket,
wherein the inner shaft member is provided with a stopper protrusion that protrudes toward the outer peripheral side at a position protruding in an axial direction from the main-body rubber elastic body, and
the outer bracket is provided with a first stopper part having an axis-perpendicular contact surface opposing the stopper protrusion at a distance in an axis-perpendicular direction, and a second stopper part having an axial-direction contact surface opposing the stopper protrusion at a distance in the axial direction, at positions protruding in the axial direction from the main-body rubber elastic body.

2. The cylindrical vibration isolation device for vehicle auxiliary machine according to claim 1, wherein the stopper protrusion is a flange part that protrudes toward an outer periphery around an entire circumference of the inner shaft member,
the outer bracket is provided with a cylindrical peripheral wall part that extends axially outward from the cylindrical part, and the first stopper part is configured by the cylindrical peripheral wall part, and
the second stopper part is configured by an inner flange-shaped part that protrudes annularly toward an inner periphery from the cylindrical peripheral wall part.

3. The cylindrical vibration isolation device for vehicle auxiliary machine according to claim 1, further comprising a stopper rubber provided between the stopper protrusion and the outer bracket,
wherein the stopper rubber comprises an axis-perpendicular buffer rubber arranged between opposing surfaces of the stopper protrusion and the first stopper part, and an axial-direction buffer rubber arranged between opposing surfaces of the stopper protrusion and the second stopper part.

4. The cylindrical vibration isolation device for vehicle auxiliary machine according to claim 3, wherein the stopper rubber is integrally formed with the main-body rubber elastic body and is fixed to the stopper protrusion of the inner shaft member.

5. The cylindrical vibration isolation device for vehicle auxiliary machine according to claim 1, wherein the vehicle auxiliary machine is an electric compressor.

6. The cylindrical vibration isolation device for vehicle auxiliary machine according to claim 1, further comprising an outer cylindrical member that is arranged at a distance on the outer peripheral side of the inner shaft member and is fixed to the main-body rubber elastic body,
wherein the outer cylindrical member is press-fit fixed to the cylindrical part of the outer bracket.

7. The cylindrical vibration isolation device for vehicle auxiliary machine according to claim 1, wherein the inner shaft member has a central axis that extends in a vehicle up-down direction,
the vehicle auxiliary machine is attached to a lower side of the inner shaft member, and
the outer bracket is attached to the support member above the vehicle auxiliary machine.

8. The cylindrical vibration isolation device for vehicle auxiliary machine according to claim 1, wherein the stopper protrusion is integrally formed with the inner shaft member.
